(19) United States
(12) Patent Application Publication
(10) Pub. No.: US 2003/0175008 A1
(43) Pub. Date: Sep. 18, 2003

(54) Content recording apparatus

(76) Inventors: Shigeru Miki, Osaka (JP); Yoshitaka Shindo, Osaka (JP)

Correspondence Address: BODNER & O'ROURKE, LLP, 425 BROADHOLLOW ROAD, SUITE 108, MELVILLE, NY, 11747, US

(21) Appl. No.: 10/359,411

(22) Filed: Feb. 6, 2003

(30) Foreign Application Priority Data
Feb. 7, 2002 (JP) 2002-31346

(51) Int. Cl. H04N 5/76; H04N 5/781

(52) U.S. Cl. 386/46; 386/125

(57) ABSTRACT

A content recording apparatus includes a light-receiving circuit, and a remote controller signal from a TV-use remote controller is received by the light-receiving circuit. When a channel selecting operation is carried out by the TV-use remote controller, reception channels of both a television receiver and a hard disk video recorder (tuner circuit) are changed. Then, in the hard disk video recorder, a TV program received at the reception channel is recorded into a hard disk.

### BACKGROUND OF THE INVENTION

1. Field of the Invention

The present invention relates to a content recording apparatus. More specifically, the present invention relates to a content recording apparatus capable of being applied to a content outputting apparatus which outputs a content signal selected in response to a selection instruction out of a plurality of content signals.

2. Description of the Prior Art

As for such a kind of a conventional content recording apparatus, there is a video tape recorder (VTR). That is, the video tape recorder, in general, when using a television receiver for watching/listening to a television broadcast (TV) program as a content outputting apparatus, is applied to the television receiver as the content recording apparatus for recording the television broadcast program of the same kind (that is, transmitted by a radio wave in the same standard). In a case that it is intended to move backward a little in order to watch/listen to once again a TV program currently watched/listened to by the television receiver to which such the video tape recorder is attached, it may video-record the same TV program by the video tape recorder at the same time of watching/listening to the TV program. In doing this, it is possible to watch/listen to the TV program currently watched/listened to once again by going backward timewise.

However, in order to video-record the same TV program as that watched/listened to by the television receiver as in the above, it needs to set to the same reception channel as the television receiver on a video tape recorder side, and carry out predetermined operations such as depressing a video-recording key, and etc. Furthermore, in a case that the reception channel is changed on a television receiver side, it needs to, at every time, repeat the predetermined operations on the video tape recorder side, thus resulting in a problem of troublesomeness.

### SUMMARY OF THE INVENTION

Therefore, it is a primary object of the present invention to provide a novel content recording apparatus.

It is another object of the present invention to provide a content recording apparatus capable of recording the same content signal as that output on a content outputting apparatus side without carrying out the above-described troublesome operations.

A content recording apparatus according to the present invention is a content recording apparatus applied to a content recording apparatus applied to a content outputting apparatus which outputs a content signal selected in response to a selection instruction out of a plurality of content signals, comprises: an inputter for inputting the plurality of content signals; a first receiver for receiving the selection instruction; a selector for selecting any one of the plurality of content signals input by the inputter in response to the selection instruction received by the first receiver; a first recorder for recording into a recording medium the content signal selected by the selector, the recording medium including a first zone and a second zone, and the first recorder recording into the first zone the selected content signal; a second receiver that receives a recording instruction; and a second recorder that records into the second zone of the recording medium a desired content signal when receiving the recording instruction by the second receiver.

In the present invention, when the selection instruction is applied to a content outputting apparatus, the content outputting apparatus selects, and outputs the content signal corresponding to the selection instruction out of a plurality of content signals. On the other hand, the plurality of content signals are also input by the inputter. In addition, the selection instruction is also received by the first receiver. In receipt of the selection instruction by the first receiver, the selector selects the content signal corresponding to the selection instruction out of the plurality of content signals. The selected content signal is recorded into the recording medium by the first recorder. That is, the same content signal as that output from the content outputting apparatus is automatically recorded into the recording medium. Then, in addition to recording into the recording medium the similar content signal as that output from the content outputting apparatus, it is possible to record into the recording medium a desired content signal. However, it is noted that the respective content signals are recorded into different zones with one another within the recording medium so that the respective content signals do not interfere with one another within the recording medium.

According to the present invention, when the selection instruction is applied to the content outputting apparatus, the content signal corresponding to the selection instruction is output from the content outputting apparatus, and recorded into the recording medium. That is, there is an advantage in that it is not needed to carry out a special operation other than an operation that applies the selection instruction for causing a specific content signal from the content outputting apparatus to be output, thus possible to record the same content signal as that output from the content outputting apparatus.

It is noted that preferably, the first recorder cyclically records the content signal into the first zone. This enables to record the same content signal as that output from the content outputting apparatus in a so-called endless manner.

Furthermore, when a recording is performed by the second recorder, it may be possible to provide a disabler for disabling the first recording medium. That is, by prioritizing the recording by the second recorder over the recording by the first recorder, the desired content signal is surely to be recorded.

It is noted that as a recording medium, a disk recording medium may be used.

A preferred embodiment is a TV program recording apparatus having a recoding medium and applicable to a television receiver which has a first receiving circuit that receives a channel selecting remote controller signal from a TV-use remote controller and sets a certain channel in response to the channel selecting remote controller signal, and comprises: a tuner circuit capable of receiving a TV program of an arbitrary channel; a second receiving circuit that receives the channel selecting remote controller signal; a CPU that sets the certain channel in the tuner circuit when receiving the channel selecting remote controller signal by the receiving circuit; and a recording circuit that records into the recording medium a TV program of the certain channel output from the tuner circuit in response to an instruction from the CPU.

If the present invention is applied to the TV program recording apparatus, the TV program of the same channel received by the television receiver is recorded into the recording medium.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing schematic structure of a hard disk video recorder regarding a first embodiment of the present invention;

FIG. 2 is an illustrative view conceptually showing structure of a remote controller signal transmitted from a TV-use remote controller in FIG. 1;

FIG. 3 is an illustrative view conceptually showing a content of a code list stored in an EEPROM in FIG. 1;

FIG. 4 is an illustrative view showing details of a code-corresponding table stored on the code list in FIG. 2;

FIG. 5 is an illustrative view conceptually showing structure inside a hard disk in FIG. 1;

FIG. 6 is a flowchart showing an operation of a CPU in FIG. 1;

FIG. 7 is a flowchart subsequent to FIG. 6;

FIG. 8 is a flowchart subsequent to FIG. 6;

FIG. 9 is a flowchart subsequent to FIG. 8;

FIG. 10 is a block diagram showing schematic structure of a hard disk video recorder (HDR) regarding a second embodiment of the present invention;

FIG. 11 is a block diagram showing internal structure of an HDR-use remote controller in FIG. 10;

FIG. 12 is a flowchart showing an operation of a CPU in FIG. 11;

FIG. 13 is a flowchart showing an operation of a CPU in FIG. 10; and

FIG. 14 is a flowchart subsequent to FIG. 13.

### DETAILED DESCRIPTION OF THE PREFERRED EMBODIMENTS

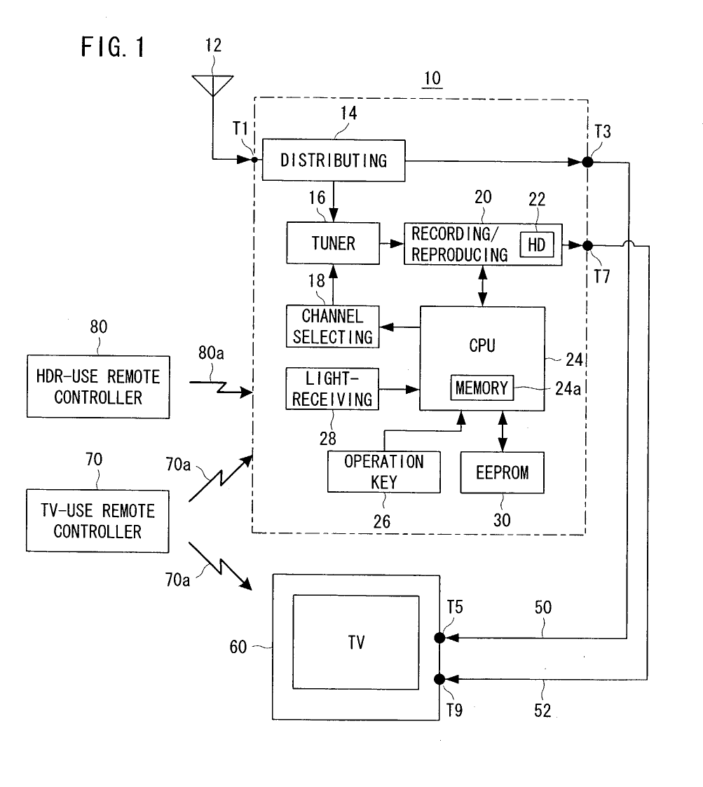

Referring to FIG. 1, a hard disk video recorder 10 of a first embodiment is for video-recording/reproducing a television broadcast program, and has an antenna input terminal T1 for connecting an external reception antenna 12. The external reception antenna 12 receives a radio wave transmitted from a television station or a relay station (both not shown) so as to convert into a high-frequency signal. A converted high-frequency signal is input into a distributing circuit 14 within the hard disk video recorder 10 via the antenna input terminal T1.

The high-frequency signal input into the distributing circuit 14 is therein distributed among two high-frequency signals. One of the distributed high-frequency signal is input into a tuner circuit 16 within the hard disk video recorder 10, and the other is supplied to an antenna output terminal T3.

The high-frequency signal supplied to the antenna output terminal T3 is input into an antenna input terminal T5 of a television receiver 60 via a single coaxial cable 50. Thus, if a reception channel of the television receiver 60 is set to a specific channel, it becomes possible to watch/listen to a TV program of the specific channel by the television receiver 60. A selection of the reception channel of the television receiver 60, that is, a station selection, is carried out by operating a channel selecting key on an operation panel (not shown) on a main body of the television receiver 60. In addition, to the television receiver 60, an exclusive remote controller 70 (hereinafter referred to as a TV-use remote controller) is attached, and it is possible to perform a similar channel selecting operation by the TV-use remote controller 70.

That is, if the channel selecting key of the TV-use remote controller 70 is operated, an infrared remote controller signal 70a is emitted from the TV-use remote controller 70 in response to the key operation. The remote controller signal 70a is decoded within the television receiver 60, after being received by a light-receiving circuit (element) (not shown) within the television receiver 60 and converted into an electronic signal. As a result of this decoding, the reception channel of the television receiver 60 is set. In addition to the channel selecting operation, a similar operation as the operation by the operation panel is possible by using the TV-use remote controller 70, that is, operations such as a sound volume adjustment of the television receiver 60, turning-on/off of a power source, and etc, for example. It is noted that the television receiver 60 is provided in the vicinity of the hard disk video recorder 10.

On the other hand, the high-frequency signal input to the tuner circuit 16 is herein subjected to a synchronization process. More specifically, the tuner circuit 16 extracts a frequency component corresponding to a desired channel out of the high-frequency signals input from the distributing circuit 14. The extraction is carried out based on the channel selecting signal supplied from the channel selecting circuit 18. Then, the tuner circuit 16 converts the extracted signal into an analog television signal, and inputs the analog television signal into a recording/reproducing circuit 20.

A recording/reproducing circuit 20 converts the input analog television signal into digital video data (including sound data, to be exact), and furthermore, compresses the digital video data in accordance to an MPEG 2 (Motion Picture Expert Group) format, for example. The sound data is compressed in accordance with an MPEG 1 audio format or an MPEG 2 audio format. Then, the compressed video data is recorded (video-recorded) within a hard disk 22 included in itself.

A series of operations that a TV program (images and sounds) of an arbitrary channel is digitalized and video-recorded into the hard disk 22 are controlled by a CPU (Central Processing Unit) 24. That is, the CPU 24, if the channel selecting key (not shown) constituting the operation key 26 is operated, controls the channel selecting circuit 18 so that the station of the channel according to the operation can be selected. Thereby, the channel selecting circuit 18 generates the above-described channel selecting signal in accordance with the channel selecting operation, and supplies the same to the tuner circuit 16. Then, if a video-recording key (not shown) constituting the operation key 26 is depressed, the CPU 24 generates a video-recording start instruction toward the recording/reproducing circuit 20 in order to start a video-recording operation of the TV program currently selected. The recording/reproducing circuit 20 starts the video-recording operation in response to the video-recording start instruction.

In order to suspend or stop the video-recording operation, a video-recording suspension key (not shown) constituting the operation key 26 may be depressed. This causes the CPU 24 to generate a video-recording suspension instruction toward the recording/reproducing circuit 22. The recording/reproducing circuit 20 suspends or stops the video-recording operation in response to the video-recording suspension instruction.

It is noted that in the hard disk video recorder 10 of this first embodiment, it is also possible to perform a reserved video-recording. More specifically, by operating the operation key 26, the channel of the TV program intended to be video-recorded, a video-recording start time ts, and a video-recording end time te are previously set. When the video-recording start time ts arrives, the CPU 24 automatically sets the reception channel of the tuner circuit 16 to the channel previously set, and starts the video-recording operation. Then, when the video-recording end time te arrives, the CPU 24 automatically stops the video-recording operation. However, in a case that the suspension key is depressed while the video-recording operation based on the reserved video-recording is under progress, the CPU 24 suspends the video-recording operation. Furthermore, in a case that at a time of the video-recording start time ts, the video-recording operation, which has started before the video-recording start time ts, is under progress, the CPU 24 does not perform the video-recording operation based on the reserved video-recording until the previously started video-recording operation completes.

On the other hand, if the reproducing key (not shown) constituting the operation key 26 is depressed, the CPU 24 enters a reproducing operation. More specifically, the CPU 24 generates a reproducing start instruction toward the recording/reproducing circuit 20 in response to a depressing of the reproducing key. Then, in response to the reproducing start instruction, the recording/reproducing circuit 20 reads out the compressed video data from the hard disk 22 so as to expand the read compressed video data. Furthermore, the recording/reproducing circuit 22 converts the expanded video data into an analog television signal before supplying the analog television signal to a video output terminal T7.

The television signal supplied to the video output terminal T7 is input into a video input terminal T9 of the television receiver 60 via a video cable 52. This allows reproduced images to be appeared on a display screen of the television receiver 60 (sounds are also reproduced concurrently with the images, to be exact).

It is noted that in a case that a plurality of TV programs are video-recorded in the hard disk 22, a TV program intended to be reproduced is selected before depressing the reproducing key. The selection of the TV program follows a predetermined operation of the operation key 26. At this time, only an arbitrary TV program is reproducible, and a plurality of programs are also continuously reproducible.

Upon completion of reproducing the intended TV program, the CPU 24 generates a reproducing suspension instruction toward the recording/reproducing circuit 20. This causes the recording/reproducing circuit 20 to suspend a series of the reproducing operations. In addition, in a case of depressing the reproducing suspension key (not shown) constituting the operation key 26 in the middle of the reproducing operation, the CPU 24 also generates the reproducing suspension instruction toward the recording/reproducing circuit 20. In this case, the reproducing operation is suspended.

As above, by using the operation key 26, it is possible to operate to select the channel, start video-recording the selected TV program, suspend the video-recording, start reproducing the video-recorded program, and suspend the reproducing. However, these operations can be also carried out by an exclusive remote controller (hereinafter referred to as HDR-use remote controller) 80 attached to the hard disk video recorder 10.

If an arbitrary operation is carried out by the HDR-use remote controller 80, an infrared remote controller signal 80a corresponding to its operation is emitted from the HDR-use remote controller 80. The remote controller signal 80a is received by a light-receiving circuit 28 within the hard disk video recorder 10, and after being converted into an electronic signal therein, input into the CPU 24. The CPU 24 decodes the input remote controller signal so as to determine the content of operation by the HDR-use remote controller 80. Then, in accordance with a determination result, the tuner circuit 16 and the recording/reproducing circuit 20 are controlled by the CPU 24, respectively.

Furthermore, the hard disk video recorder 10 of the first embodiment uses the hard disk 22 as a recording medium for video-recording TV programs, thus capable of simultaneously carrying out the video-recording operation and the reproducing operation. That is, the hard disk 22, different from a tape-shaped recording medium such as a video tape, is randomly accessible, and in addition, its access speed is extremely so high that the video-recording operation and the reproducing operation are simultaneously implemented by alternately carrying out (that is, time-sharing) a writing of the compressed video data into the hard disk 22 and a reading of the compressed video data from the hard disk 22. Therefore, in addition to video-recording the TV program currently received, it is possible to simultaneously reproduce the TV program already recorded. In addition, a so-called after recording reproduction, which reproduces the TV program currently being video-recorded (received) with a time delay, is also possible.

Incidentally, the hard disk video recorder 10 of the first embodiment is, in addition to a so-called normal video-recording function, which is to carry out the video-recording operation by depressing the above-described operation key 26 or the video-recording key of the HDR-use remote controller 80, and the reserved video-recording function based on the reserved video-recording, provided with a so-called simultaneous video-recording function, which is to carry out the video-recording, and simultaneously watch/listen to a TV program currently watched/listened to by the television receiver 60. Furthermore, in order to realize the simultaneous video-recording function, the hard disk video recorder 10 uses, as the light-receiving circuit 28, a circuit (element) capable of receiving even the remote controller signal 70a irradiated from the TV-use remote controller 70, and has an EEPROM (Electrically Erasable Programmable ROM) 30 on which a code list described later is stored.

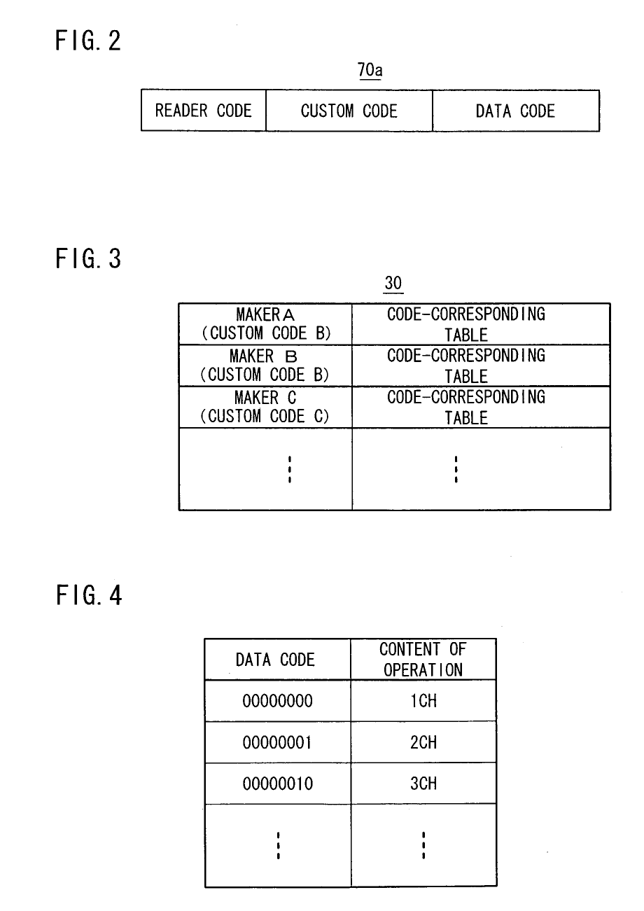

More specifically, the remote controller signal 70a generated from the TV-use remote controller 70 is constructed in such a manner that three codes, e.g. a reader code, a custom code and a data code are lined in time-sequence order as shown in FIG. 2. Of these codes, the reader code is a code for evaluating a light-receiving sensitivity on a light-receiving side (the light-receiving circuit within the television receiver 60 or the light-receiving circuit 28 within the hard disk video recorder 10), and on the light-receiving side, it is determined whether or not the light-receiving sensitivity is sufficient depending on a magnitude of an amplitude of the reader code. Next, the custom code represents a maker or manufacturer of the television receiver 60 (also represents a kind of apparatuses (such as a television receiver, a VTR, and etc), to be exact). The data code represents a content of operation by the TV-use remote controller 70.

On the other hand, in the EEPROM 30, as the above-described code list, a list of a plurality of makers or manufacturers (custom code) thought of as makers or manufacturers of the television receiver 60, and a code-corresponding table for each maker or manufacturer are stored as shown in FIG. 3. The code-corresponding table is, as shown in FIG. 4, a table that represents a correspondence relationship between a kind of data codes (data of 8 [bit], in the same Figure) and the content of operation by the TV-use remote controller 70. The correspondence relationship is uniquely defined for each maker or manufacturer.

Next, assuming that a channel selecting operation, which is to select an arbitrary channel, is carried out by the TV-use remote controller 70, as described above, the remote controller signal 70a is emitted from the TV-use remote controller 70, thereby setting the channel of the television receiver 60 in accordance with the remote controller signal 70a. At the same time, the remote controller signal 70a emitted from the TV-use remote controller 70 is also received by the light-receiving circuit 28 of the hard disk video recorder 10.

The remote controller signal 70a received by the light-receiving circuit 28 is herein converted into an electronic signal before being input to the CPU 24. The CPU 24 decodes the input remote controller signal 70a so as to determine whether or not the reception sensitivity is sufficient from the above-described reader code. Then, in a case of obtaining the sufficient reception sensitivity, the maker or manufacture of the television receiver 60 is specified by referring to the above-described custom code and the code list within the EEPROM 30. Furthermore, by referring to the above-described data code and the code-corresponding table of the specified maker or manufacturer, the content of operation by the TV-use remote controller 70 is determined.

The CPU 24 recognizes the channel set on the television receiver 60 side based on the determination result, and controls the channel selecting circuit 18 in such a manner that the same channel can be selected by the tuner circuit 16. Then, after setting the channel, the CPU 24 controls the recording/reproducing circuit 20 so as to start the video-recording operation (that is, generates the video-recording start instruction). This allows the TV program of the same channel currently received by the television receiver 60 to be simultaneously recorded into the hard disk 22.

With this state, if the channel selecting operation, which is to select another channel, is carried out by the TV-use remote controller 70, the reception channel of the television receiver 60 is changed in accordance with the channel selecting operation. On the other hand, on the hard disk video recorder 10 side, when it is recognized that the channel selecting operation is carried out, the video-recording operation is temporarily suspended (that is, the video-recording suspension instruction is applied to the recording/reproducing circuit 20). Then, after setting the reception channel by the tuner circuit 16 according to the same manner as above, the video-recording operation is resumed.

That is, according to the simultaneous video-recording function, when the reception channel of the television receiver 70 is set by operating the TV-use remote controller 70, the same channel is automatically set on the hard disk video recorder 10 (tuner circuit 16) side, which automatically video-records the TV program of this channel. In other words, the same TV program as the TV program watched/listened to by the television receiver 60 is video-recorded into the hard disk video recorder 10 (hard disk 22) without carrying out a special operation other than the channel selecting operation by the TV-use remote controller 70.

It is noted that in case that an operation other than the channel selecting operation is carried out by the TV-use remote controller 70, a process according to the content of operation is, without question, carried out on the television receiver 70 side. However, the operation is ignored on the hard disk video recorder 10 side. In addition, in a case of carrying out the channel selecting operation by the operation panel of the television receiver 70 itself, the channel on the hard disk video recorder 10 side is not changed.

On the other hand, in a case of carrying out the channel selecting operation (depressing of the channel selecting key) by the operation key 26 of the hard disk video recorder 10 or the HDR-use remote controller 80, the reception channel on the hard disk video recorder 10 side is changed. However, the reception channel on the television receiver 60 side is not changed. Thus, in a case of carrying out the channel selecting operation by the operation key 26 or the HDR-use remote controller 80, the video-recording operation based on the simultaneous video-recording function is suspended, and no video-recording operation is executed until the channel selecting operation by the TV-use remote controller 70 is carried out again.

Furthermore, in a case that the video-recording operation is carried out based on the normal video-recording function (video-recording operation through depression of the operation key 26 or the video-recording key of the HDR-use remote controller 80) or the reserved video-recording function (video-recording operation by the reserved video-recording) described above, the channel selecting operation is ignored even if the channel selecting operation is carried out by the operation key 26 or the HDR-use remote controller 80. That is, the reception channel of the hard disk video recorder 10 is not changed. In addition, in a case of carrying out the channel selecting operation by the TV-use remote controller 70 during a time that the video-recording operation is performed based on such the normal video-recording function or the reserved video-recording function, also the channel selecting operation is likewise ignored.

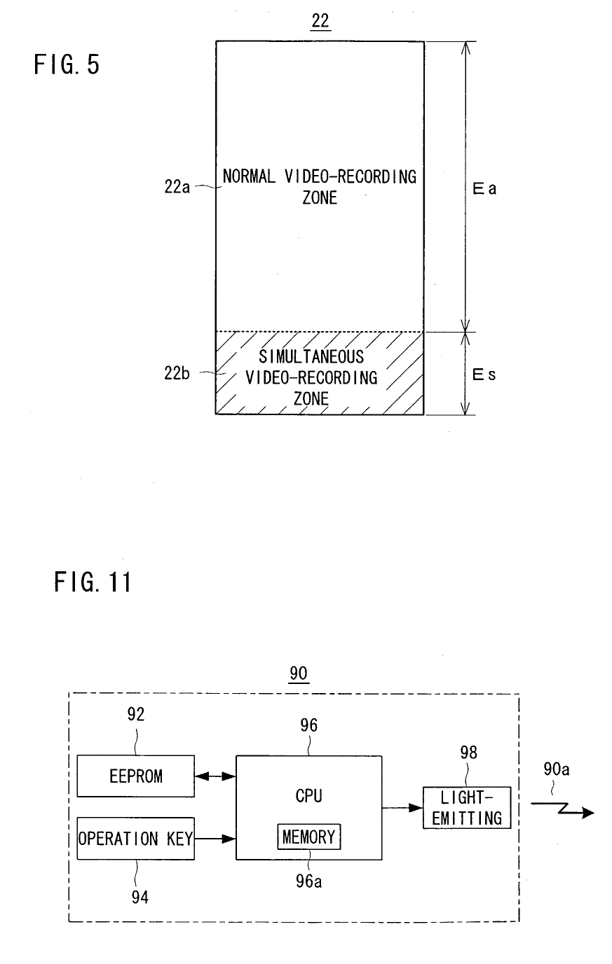

It is noted that as shown in FIG. 5, within the hard disk 22, two recording zones, which are a normal video-recording zone 22a and a simultaneous video-recording zone 22b, are provided. Of the two, the normal video-recording zone 22a is a zone for video-recording a TV program by the normal video-recording function and the reserved video-recording function. On the other hand, the simultaneous video-recording zone 22b is a zone for video-recording a TV program by the simultaneous video-recording function. By the video-recording zone 22b in exclusive use for the simultaneous video-recording function is thus separately provided in addition to the other normal video-recording zone 22a, a capacity of the hard disk 22 is prevented from being consumed more than necessary (that is, only for the sake of compensating oversight).

Moreover, if a vacant capacity of the normal video-recording zone 22a is depleted (when it becomes less than a predetermined capacity, to be exact), unless a predetermined operation is carried out by the operation key 26 or the HDR-use remote controller 80, the recorded data (TV program) is not erased. On the other hand, regarding the simultaneous video-recording zone 22b, when a vacant capacity is depleted, older data is overwritten in ascending order of time. It is noted that it is appropriate that a ratio (Ea:Eb) between a capacity Ea of the normal video-recording zone 22a and a capacity Eb of the simultaneous video-recording zone 22b is approximately at 9:1. The ratio is arbitrarily settable by operating the operation key 26 or the HDR-use remote controller 80.

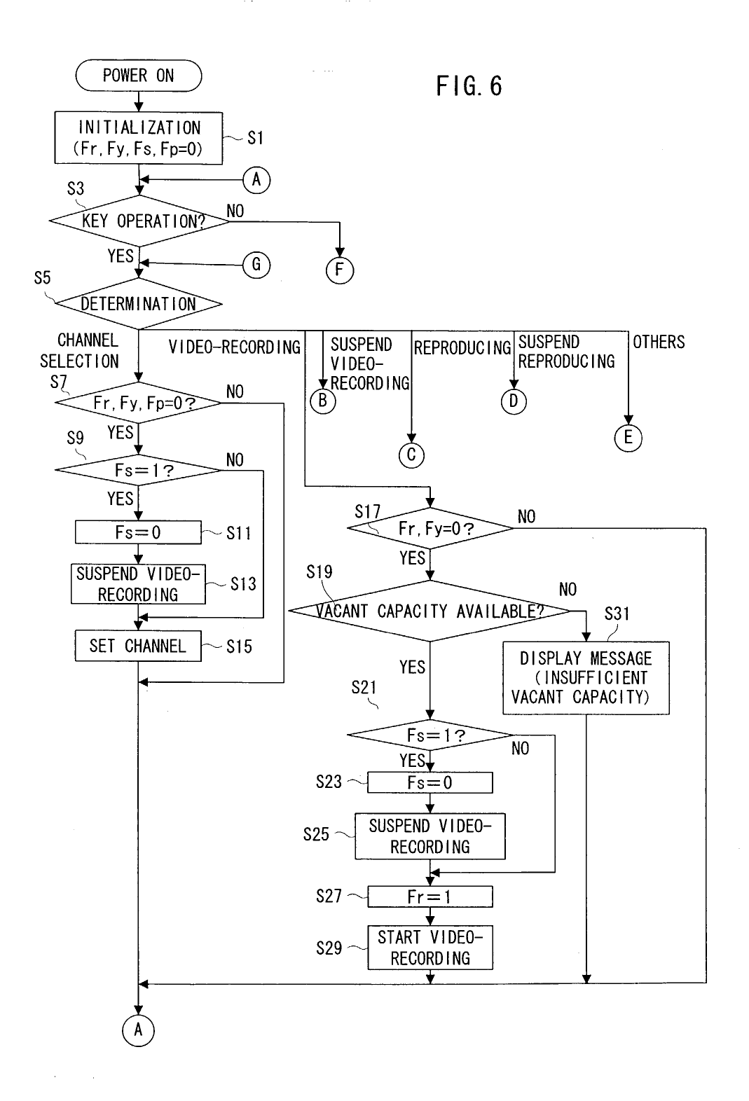

In realizing the above-described series of operations, the CPU 24 of the first embodiment carries out respective processes shown in flowcharts in FIG. 6-FIG. 9. It is noted that a so-called control program for causing the CPU 24 to carry out such the processes is stored in a program memory 24a within the CPU 24.

Referring to FIG. 6, when a power switch (not shown) of the hard disk video recorder 10 is turned-on, the CPU 24 carries out an initialization in a step S1, more specifically, renders all of four flags Fr, Fy, Fs, and Fp “0”. Of the four, the flag Fr shows whether or not the video-recording operation based on the above-described normal video-recording function is carried out. When the flag Fr is “0”, the video-recording operation is not carried out, and “1” means that the video-recording operation is in progress. Next, the flag Fy shows whether or not the video-recording operation based on the reserved video-recording function is carried out. When the flag Fy is “0”, no video-recording operation is carried out, and “1” means that the video-recording operation is in progress. In addition, the flag Fs shows whether or not the video-recording operation based on the simultaneous video-recording function is carried out. When the flag Fs is “0”, no video-recording operation is carried out, and “1” means that the video-recording operation is under progress. Furthermore, the flag Fp shows whether or not the reproducing operation is under progress, if the flag Fp is “0”, no reproducing operation is carried out, and “1” means that the reproducing operation is under progress.

Upon completion of the initialization in the step S1, the CPU 24 advances to a step S3 so as to determine whether or not any key operation is carried out by the operation key 26. If it is determined that some key operation is carried out by the operation key 26, the CPU 24 advances to a step S5 so as to determine a content of operation.

If it is determined that the channel selecting key is operated in the step S5, the CPU 24 advances to a step S7, and determines whether or not all the flags Fr, Fy, and Fp are “0”, in other words, determines whether or not any one of the normal video-recording, the reserved video-recording, and the reproducing operation is currently performed. Herein, if all the flags Fr, Fy, and Fp are “0”, the CPU 24 determines that none of the normal video-recording, the reserved video-recording, and the reproducing operation is operated, and then, advances to a step S9. Then, in the step S9, it is determined whether or not the flag Fs is “1”, that is, whether or not the simultaneous video-recording is currently under progress.

When the flag Fs is “1” in the step S9, the CPU 24 determines that currently the simultaneous video-recording is under progress. Then, after rendering the flag Fs “0” in a step S11, the video-recording operation (simultaneous video-recording) is suspended in a step S13 before advancing to a step S15. On the other hand, in the step S9, when the flag Fs is not “1” (that is, when “0”) the CPU 24 determines that the simultaneous video-recording is not currently in progress before directly advancing to the step S15 while skipping the step S11 and the step S13.

In the step S15, the CPU 24 sets a reception channel of the tuner circuit 16 to a channel corresponding to an operation of the channel selecting key. Then, after setting the channel, the CPU 24 returns to the step S3. It is noted that in a case that any one of the flags Fr, Fy, and Fp is “1” in the above-described step S7, the CPU 24 determines that any one of the normal video-recording, the reserved video-recording, and the reproducing operation is carried out, and then, directly returns to the step S3 from the step S7.

In the step S5, if it is determined that the recording key is depressed, the CPU 24 advances to a step S17. Then, in the step S17, it is determined whether or not both the flags Fr and Fy are “0”. Herein, in a case that both the flags Fr and Fy are “0”, the CPU 24 advances to a step S19 so as to detect a vacant capacity of the hard disk 22 (normal video-recording zone 22a, to be exact). Herein, in a case that the vacant capacity is available, the CPU 24 advances to a step S21 so as to determine whether or not the flag Fs is “1”.

When the flag Fs is “1” in the step S21, the CPU 24 advances to a step S23, and after rendering the flag Fs “0”, suspends the video-recording operation (simultaneous video-recording) in a step S25. Then, after rendering the flag Fr “1” in a step S27, the video-recording operation (normal video-recording ) is started in a step S29. It is noted that when the flag Fr is rendered “1” in the step S27, the CPU 24 designates the normal video-recording zone 22a of the hard disk 22 as a video-recording destination of the TV program (recording destination of the compressed video data). Then, after starting the video-recording operation, the CPU 24 returns to the step S3. On the other hand, when the flag Fs is not “1” (that is, “0”) in the step S21, the CPU 24 directly advances to the step S27 while skipping the step S23 and the step S25.

In a case that it is determined that there is no vacant capacity in the hard disk 22 in the above-described step S19, the CPU 24 advances to a step S31. Then, after displaying a message that informs of insufficiency of the vacant capacity of the hard disk 22 on a display of the operation panel (not shown) in the step S31, the process returns to the step S3. In addition, in a case that one of the flags Fr and Fy is not “0” (that is, “1”) in the step S17, the CPU 24 directly returns to the step S3 from the step S17.

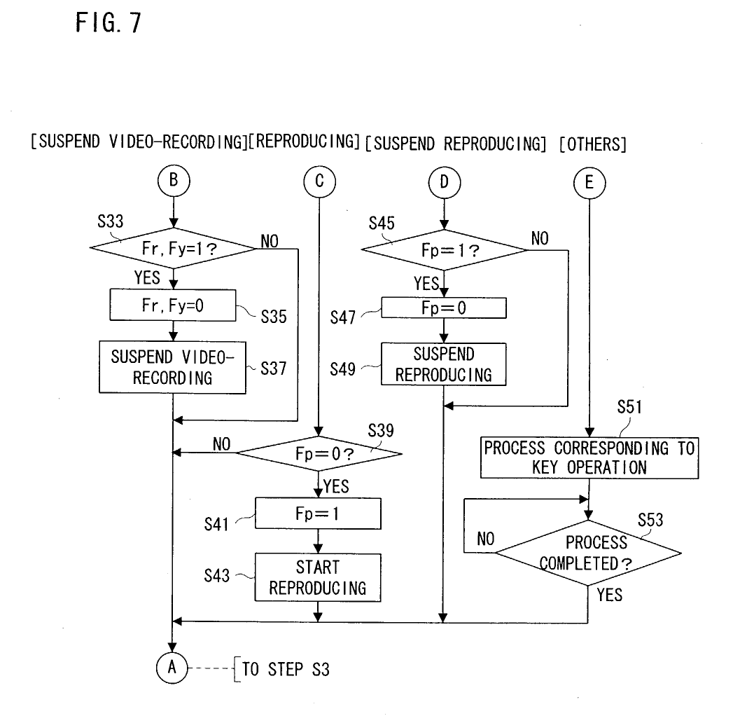

Furthermore, if it is determined that the video-recording suspension key is depressed in the step S5, the CPU 24 advances to a step S33 in FIG. 7. Then, in the step S33, it is determined whether or not both the flags Fr and Fy are “1”. Herein, in a case that the both the flags Fr and Fy are “1”, the CPU 24 suspends the video-recording operation (normal video-recording or reserved video-recording) in a step S37 after rendering both the respective flags Fr and Fy “0” in a step S35. Next, after suspending the video-recording operation, the CPU 24 returns to the step S3 in FIG. 6. On the other hand, in a case that none of the flags Fr and Fy is “0” (that is, “0”) in the step S33, the CPU 24 directly returns to the step S3 from the step S33.

Furthermore, if it is determined that the reproducing key is depressed in the step S5 in FIG. 6, the CPU 24 advances to a step S39 in FIG. 7. Then, it is determined whether or not the flag Fp is “0” in the step S39. Herein, in a case that the flag Fp is “0”, the CPU 24 starts the reproducing operation in a step S43 after rendering the flag Fp “1” in a step S41. Then, after starting the reproducing operation, the CPU 24 returns to the step S3 in FIG. 6. On the other hand, in a case that the flag Fp is not “0” (that is, “1”) in the step S39, the CPU 24 directly returns to the step S3 from the step S39.

Then, in the step S5 in FIG. 6, if it is determined that the reproducing suspension key is depressed, the CPU 24 advances to a step S45 in FIG. 7. In the step S45, the CPU 24 determine whether or not the flag Fp is “1”, and in a case of “1”, the process advances to a step S47. Then, after rendering the flag Fp “0” in the step S47, the reproducing operation is suspended in a step S49. Then, after suspending the reproducing operation, the CPU 24 returns to the step S3 in FIG. 6. On the other hand, in a case that the flag Fp is not “1” (that is, “0”) in the step S45, the CPU 24 directly returns to the step S3 from the step S45.

It is noted that if it is determined that a key operation other than depressing the channel selecting key, the video-recording suspension key in the step S5 in FIG. 6, the reproducing key, and reproducing suspension key is carried out, the CPU 24 advances to a step S51 in FIG. 7. Then, in the step S51, a process corresponding to the key operation is carried out, and in a step S53, it is determined whether or not the process is completed. Then, upon completion of the process, the process returns to the step S3 in FIG. 6.

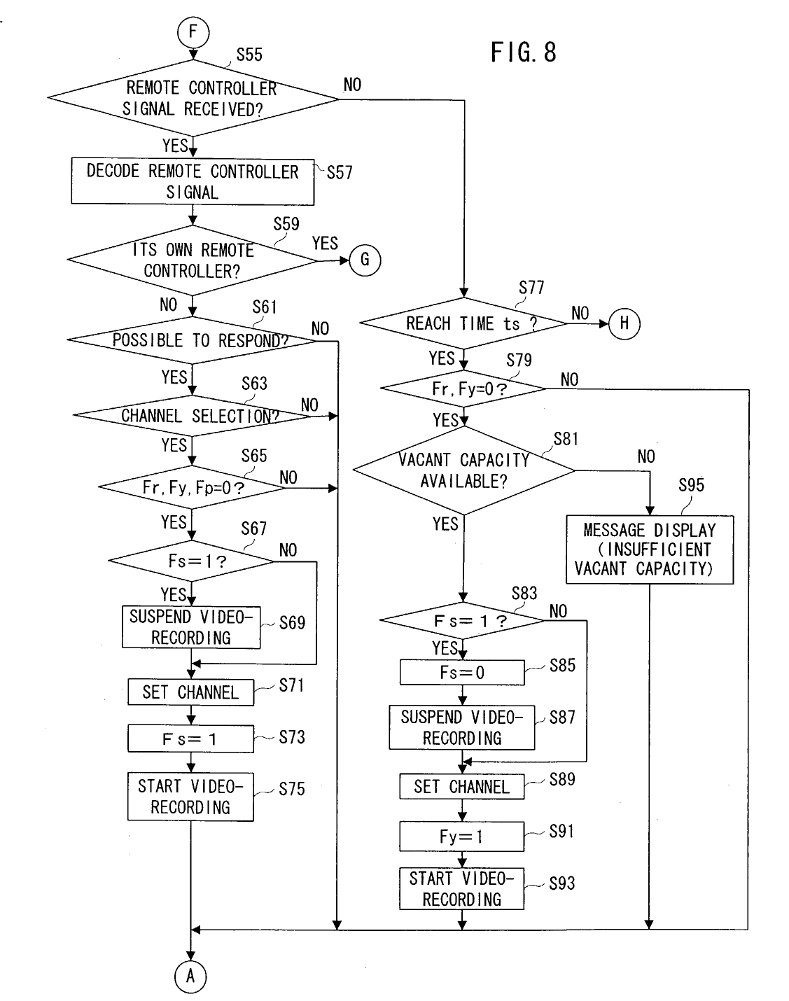

It is noted that if it is determined that the key operation by the operation key 26 is not carried out in the step S3, the CPU 24 advances to a step S55 in FIG. 8. Then, in the step S55, it is determined whether or not a remote controller signal is received from any remote controller including the TV-use remote controller 70 and the HDR-use remote controller 80 (that is, whether or not any remote controller signal is received by the light-receiving circuit 28). Herein, if it is determined that the remote controller signal is received, the CPU 24 advances to a step S57 so as to decode the remote controller signal. Then, it is determined whether or not the remote controller signal received from the decoded code (custom code) is transmitted from its own HDR-use remote controller 80, and in a case of a signal transmitted from its own HDR-use remote controller 80, the process returns to the step S5 in FIG. 6. On the other hand, in a case that it is determined that it is a signal transmitted from a remote controller other than its own HDR-use remote controller 80, the CPU 24 advances to a step S61.

In the step S61, the CPU 24 determines whether or not it is possible for the CPU itself to respond to the transmitted remote controller signal, more specifically, determines whether or not the decoded code (custom code) is present within the code list in the EEPROM 30. Herein, in a case that the decoded code is present within the code list, the CPU 24 determines that it is possible to respond before advancing to a step S63. On the other hand, in a case that the decode code is not present within the code list, the CPU 24 determines that it is not possible to respond (that is, the transmitted remote controller signal is a signal transmitted from an apparatus other than the television receiver 60 such as a VTR, and etc, for example) before returning to the step S3 in FIG. 6.

In the step S63, the CPU 24 determines whether or not the decoded code (data code) represents the channel selecting operation. Herein, in a case that the code represents the channel selecting operation, the CPU 24 advances to a step S65. On the other hand, in a case of representing an operation other than the channel selecting operation, the process returns to the step S3 in FIG. 6.

In the step S65, the CPU 24 determines whether or not all the flags Fr, Fy and Fp are “0”. Herein, in a case that all the flags Fr, Fy and Fp are “0”, the CPU 24 advances to a step S67. In contrary, in a case that any one of the flags Fr, Fy and Fp is not “0” (that is, “1”), the CPU 24 returns to the step S3 in FIG. 6.

In the step S67, the CPU 24 determines whether or not the flag Fs is “1”. In a case that the flag Fs is “1”, the CPU 24 advances to a step S69, and after suspending the video-recording operation (simultaneous video-recording), advances to a step S71. On the other hand, in a case that the flag Fs is not “1” (that is, “0”), the CPU 24 directly advances to the step S71 while skipping the step S69.

In the step S71, the CPU 24, in accordance with the code (data code) decoded in the above-described step S57, sets the reception channel of the tuner circuit 16. Then, after setting the channel, the CPU 24, after rendering the flag Fs “1” in a step S73, starts the video-recording operation in a step S75. At this time, that is, when rendering the flag Fs “1”, the CPU 24 designates the simultaneous video-recording zone 22b of the hard disk 22 as a video-recording destination. Then, after starting the video-recording operation, the CPU 24 returns to the step S3 in FIG. 6.

In the above-described step S55, if it is determined that the remote controller signal is not received, the CPU 24 further advances to a step S77. In the step S77, the CPU 24 determines whether or not a present time has reached the video-recording start time ts set by the video-recording reservation function. Then, if it is determined that it has reached the video-recording start time ts, the process advances to a step S79 so as to determine whether or not both the flags Fr and Fy are “0”. Herein, in a case that both the flags Fr and Fy are “0”, the CPU 24 advances to a step S81 so as to detect a vacant capacity of the hard disk 22. Herein, in a case that the vacant capacity is available, the CPU 24 advances to a step S83, and determines whether or not the flag Fs is “1”.

When the flag Fs is “1” in the step S83, the CPU 24 advances to a step S85, and after rendering the flag Fs “0”, suspends the video-recording operation (simultaneous video-recording) in a step S87. Then, the CPU 24, after changing the reception channel of the tuner circuit 16 to the channel set by the reservation in a step S89, advances to a step S91. The CPU 24, after rendering the flag Fy “1” in the step S91, advances to the step S93 so as to start the video-recording operation (simultaneous video-recording). At this time, that is, when rendering the flag Fy “1”, similar to a case that the flag Fr is rendered “1”, the CPU 24 designates the normal video-recording zone 22a of the hard disk 22 as a video-recording destination of the TV program. Then, after starting the video-recording operation, the CPU 24 returns to the step S3 in FIG. 6.

It is noted if it is determined that there is no vacant capacity of the hard disk 22 in the above-described step S81, the CPU 24 advances a step S95. Then, after displaying a message that informs of insufficiency of the vacant capacity of the hard disk 22 on the above-described display in the step S95, the process returns to the step S3.

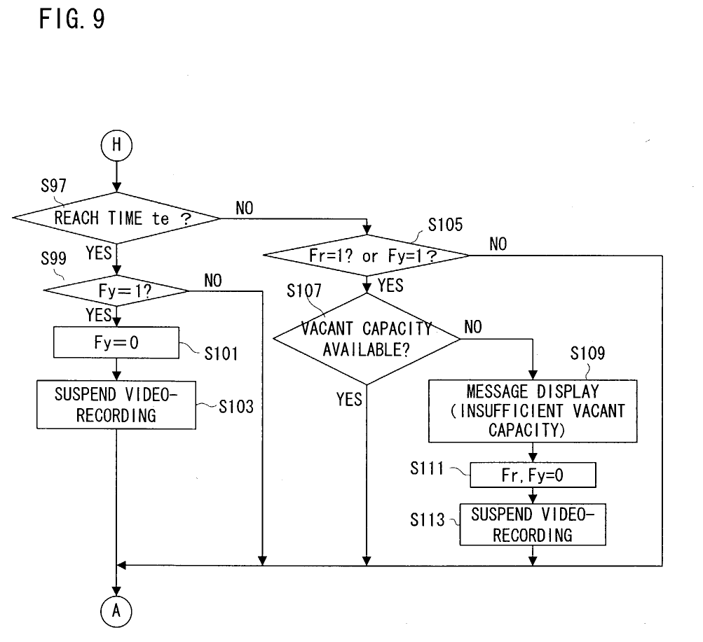

Furthermore, in a case that it is determined that the present time has not reached the video-recording start time ts in the above-described step S77 or in a case that it is determined that the reserved video-recording is not carried out, the CPU 24 advances to a step S97 in FIG. 9. Then, in the step S97, it is determined whether or not the present time reaches a video-recording end time te set in the reserved video-recording.

If it is determined that the present time has reached the video-recording end time te in the step S97, the CPU 24 advances to a step S99 so as to determine whether or not the flag Fy is “1”. Then, in a case that the flag is “1”, the CPU 24 advances to a step S101, and after rendering the flag Fy “0”, suspends the video-recording operation (reserved video-recording) in a step S103. Then, after suspending the video-recording operation, the CPU 24 returns to the step S3 in FIG. 6. Meanwhile, in a case that the flag Fy is not “1” (that is, “0”) in the step S99, the CPU 24 directly returns to the step S3 from the step S9.

Next, in a case that it is determined that the present time has not reached the video-recording start time te in the above-described step S97 or in a case that it is determined that the reserved video-recording is not programmed, the CPU 24 advances to a step S105. Then, in the step S105, it is determined whether or not any of the flags Fr and Fy is “1”. Herein, in a case that any one of the flags Fr and Fy is “1”, the CPU 24 advances to a step S107. Then, in the step S107, a vacant capacity of the hard disk 22 is detected, and in a case that a vacant capacity is available, the process returns to the step S3 in FIG. 6.

On the other hand, in a case that there is no vacant capacity of the hard disk 22 in the step S107, the CPU 24 advances to a step S109. Then, after displaying a message that informs of insufficiency of the vacant capacity of the hard disk 22 on the above-described display in the step S109, the process advances to a step S1 so as to render both the flags Fr and Fy “0”. Furthermore, after suspending the video-recording operation in a step S113, the CPU 24 returns to the step S3.

It is noted that in a case that neither of the flags Fr nor Fy is “1” (that is, “0”) in the above-described step S105, the CPU 24 directly returns to the step S3 from the step S105.

As understood from the above descriptions, according to the first embodiment, when the channel selecting operation is carried out by the TV-use remote controller 70, a TV program at the channel corresponding to the channel selecting operation is displayed on a display screen of the television receiver 60. At the same time, the same TV program as that appeared on the television receiver 60 is video-recorded into the hard disk video recorder 10 (hard disk 22). Thus, if the above-described after recording reproduction is used, it becomes possible to watch/listen to the TV program going backward the TV program currently watched/listened to.

It is noted that in the first embodiment, the remote controller signal 70a irradiated from the TV-use remote controller 70 when the channel selecting operation is carried out by the TV-use remote controller 70 corresponds to a selection instruction, and a portion formed of the light-receiving circuit 28 and the CPU 24 corresponds to a first receiver (or receiver). Furthermore, a portion structured of the CPU 24, the station selection circuit 28, and the tuner circuit 16 correspond to a selector.

In addition, the simultaneous video-recording zone 22b within the hard disk 22 corresponds to a first zone, and the normal video-recording zone 22a corresponds to a second zone. Then, at a time of the above-described simultaneous video-recording, the CPU 24 and the recording/reproducing circuit 20 functions as a first recorder (recorder), and at a time of the normal video-recording and the reserved video-recording, functions as a second recorder.

Furthermore, the remote controller signal 80a irradiated from the HDR-use remote controller 80 when the recording key of the HDR-use remote controller 80 is depressed or the signal applied to the CPU 24 from the operation key 26 in response to a depression of the video-recording key of the operation key 26 corresponds to a recording instruction. Then, a portion formed of the light-receiving circuit 28 and the CPU 24 at a time of receiving the remote controller signal 80a or a portion that recognizes an instruction applied from the operation key 26 of the CPU 24 corresponds to a second receiver.

Next, a second embodiment of the present invention is described.

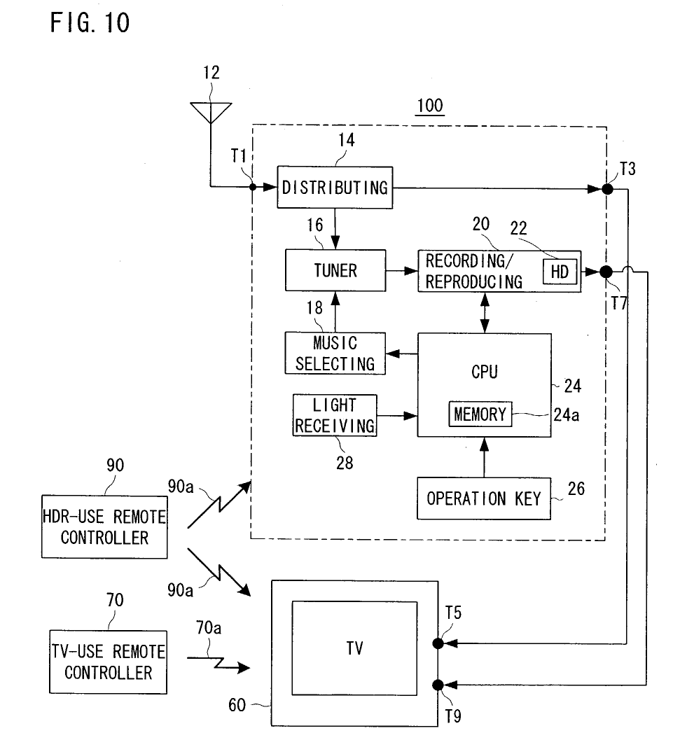

Referring to FIG. 10, a hard disk video recorder 100 of the second embodiment is an apparatus that omits the EEPROM 30 from the structure of the hard disk video recorder 10 of the first embodiment. Then, in place of the HDR-use remote controller 80 of the first embodiment, a HDR-use remote controller 90 constructed as shown in FIG. 11 is used. It is noted that although not understood from the drawings, a difference between the first and second embodiments in this structure allows a CPU 24 of the second embodiment to operate slight differently from the first embodiment. That is, the control program stored in the program memory 24a is slightly different from that of the first embodiment. The detailed operations will be described later. Regarding the structure other than this, by applying identical reference numerals to the same or similar portions, detailed descriptions are herein omitted since they are the same or similar to those of the first embodiment.

Referring to FIG. 11, the HDR-use remote controller 90 of the second embodiment contains an EEPROM 92 in which the same code list as the EEPROM 30 in the first embodiment is stored. The EEPROM 92 is, along with an operation key 94 of the HDR-use remote controller 90 itself, connected to a CPU 96, and a light-emitting circuit (element) 98 for emitting a remote controller signal is also connected to the CPU 96.

That is, in the second embodiment, if a channel selecting key (not shown) forming the operation key 94 of the HDR-use remote controller 90 is depressed, the CPU 96 reads out from the EEPROM 92 two kinds of codes for receiving by the television receiver 60 and the hard disk video recorder 100, respectively, and sequentially emits or irradiates remote controller signals 90a in accordance with the respective two kinds of the read codes in a time-sharing manner from the light-emitting circuit 98.

Meanwhile, on a hard disk video recorder 100 side, the CPU 24 determined whether or not the received remote controller signal 90a is transmitted from the HDR-use remote controller 90, and whether or not the signal is concerned with the channel selecting operation. Then, in a case that the remote controller signal 90a is a signal transmitted from the HDR-use remote controller 90, and a signal concerned with the channel selecting operation, the CPU 24, after setting the reception channel of the tuner circuit 16 to a channel in accordance with the channel selecting operation, video-records a TV program at the channel received by the tuner circuit 16 so as to carry out the same simultaneous video-recording as the first embodiment.

It is noted that in a case that even if the remote controller signal 90a regarding the channel selecting operation from the HDR-use remote controller 90 is received at a time that the normal video-recording or the reserved video-recording is under progress, the simultaneous video-recording is not carried out. Furthermore, when the channel selecting operation (depressing the channel selecting key) is carried out by the operation key 26 of the hard disk video recorder 100 itself, the simultaneous video-recording is suspended, and only the reception channel of the hard disk video recorder 100 (tuner circuit 16) is changed. Then, the remote controller signal 70a irradiated from the TV-use remote controller 70 is completely ignored on the hard disk video recorder 100 side.

In addition, in a case that an operation other than the channel selecting operation is carried out by the operation key 94 of the HDR-use remote controller 90, the CPU 96 within the HDR-use remote controller 90, in accordance with the content of operation, causes only the remote controller signal 90a for controlling the hard disk video recorder 100 to be irradiated from the light-emitting circuit 98. Then, when using the HDR-use remote controller 90, a maker or manufacturer of the television receiver 60 is set by carrying out a predetermined operation by the operation key 94. Thus, by setting in advance the maker or manufacturer of the television receiver 60 being an object to be controlled, when the channel selecting operation is carried out by the operation key 94, makes it possible to read out from the EEPROM 92 an appropriate code for setting the reception channel of the television receiver 60 according to the channel selecting operation.

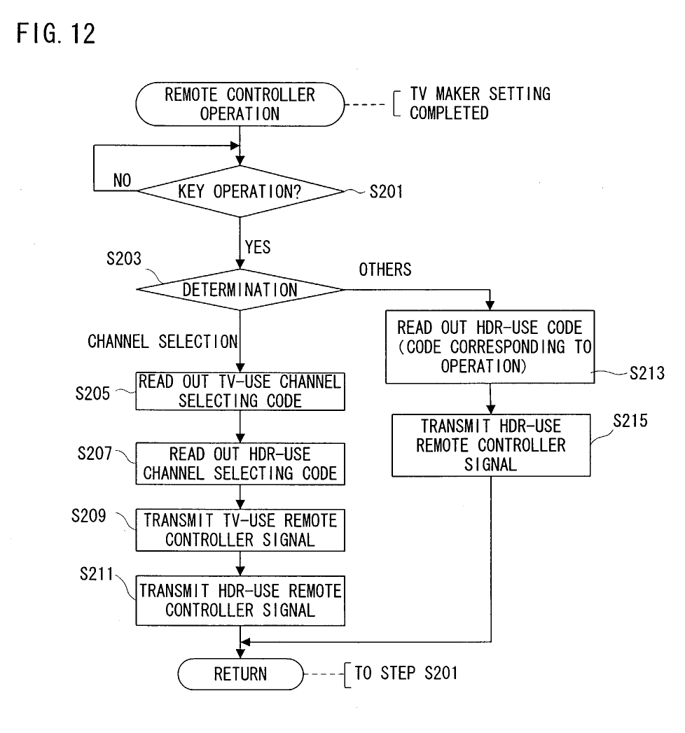

In order to thus irradiate the remote controller signal 90a in accordance with the channel selecting operation by the operation key 94, the CPU 96 within the HDR-use remote controller 90 carries out such the processes shown in a flowchart in FIG. 12. It is noted that a control program for allowing the CPU 96 to carry out the processes is stored in a program memory 96a within the CPU 96. In addition, before carrying out the flowchart shown in FIG. 12, the above-described setting of the maker or manufacturer of the television 60 is conditioned to be carried out in advance.

As shown in FIG. 12, the CPU 96 determines whether or not any operation is carried out by the operation key 94 in a step S201. Herein, if a certain key operation is carried out, the CPU 96 advances to a step S203 so as to determine the content of operation.

In the step S203, if it is determined that the channel selecting operation is carried out, the CPU 96 advances to a step S205 so as to read out from the EEPROM 92 the code for setting the reception channel in response to the channel selecting operation to the television receiver 60, and then, reads out from the EEPROM 92 the code for setting the same reception channel to the hard disk video recorder 100 side (tuner circuit 16) in a step S207.

Furthermore, the CPU 96 makes, in a step S209, based on the read code in the above-described step S205, the remote controller signal 90a for setting the reception channel of the television receiver 60 be irradiated. Likewise, in a step S211, based on the code read out in the above-described step S207, the remote controller signal 90a for setting the reception channel of the hard disk video recorder 100 is irradiated. Then, after the process of the step S211, the CPU 96 returns to the step S201 in order to wait for a next key operation.

On the other hand, in the step S203, if it is determined that an operation other than the channel selecting operation is carried out by the operation key 94, the CPU 96 advances to a step S213. Next, in the step S213, the code corresponding to the content of operation of the operation key 94 is read out from the EEPROM 92. Then, in a step S215, after irradiating the remote controller signal 90 corresponding to the read code, the process returns to the step S201.

In correspondence to such the operation of the CPU 96 on the HDR-use remote controller 90 side, the CPU 24 on the hard disk video recorder 100 side carries out following operations.

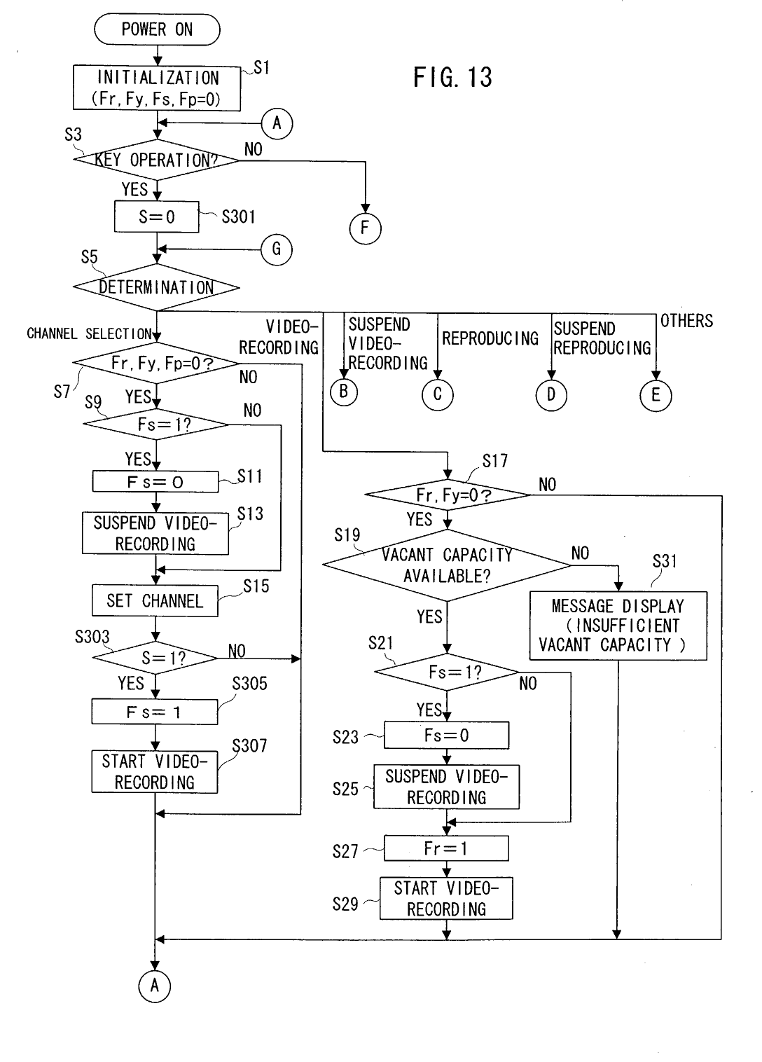

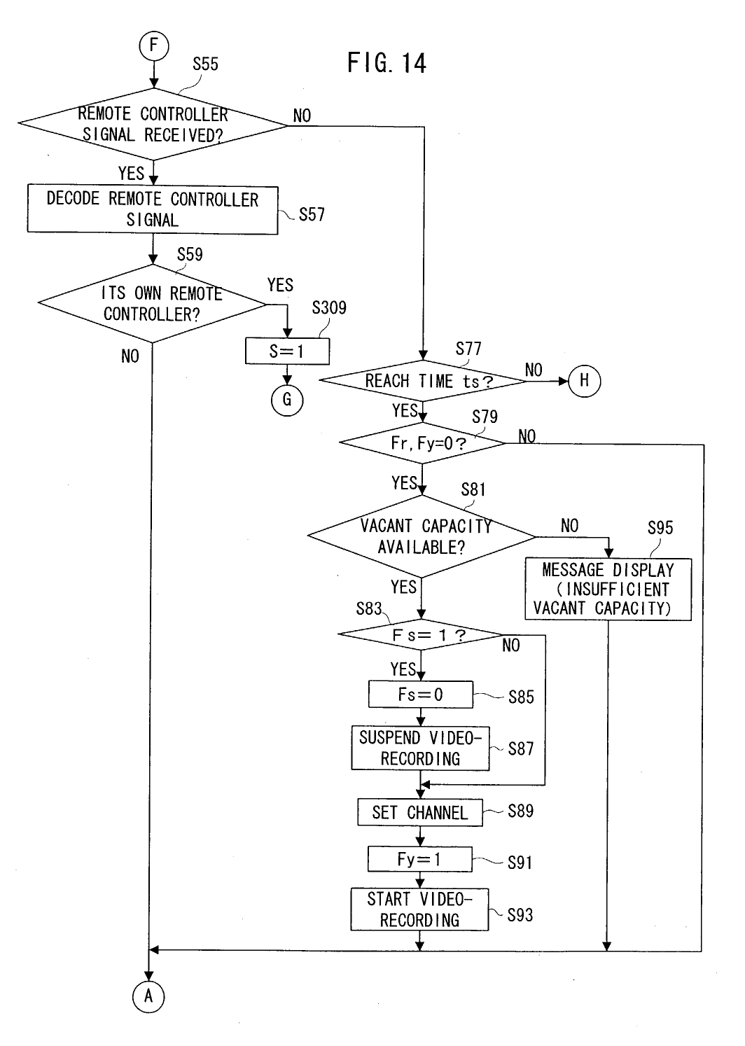

That is, the CPU 24 in the second embodiment, in place of the processes shown in the above-described flowchart in FIG. 6, carries out processes shown in a flowchart in FIG. 13. In addition, in place of the processes shown in the above-described flowchart in FIG. 8, processes shown in a flowchart in FIG. 14 are carried out.

Referring to FIG. 13, the CPU 24, if it is determined that the key operation by the operation key 26 in the step S3 is carried out, advances to a step S301 so as to render a predetermined flag S “0”. The flag S is a flag that shows whether or not the remote controller signal 90a is received from the HDR-use remote controller 90, and when the flag S is “1”, it shows the remote controller signal 90a is received, while the flag being “0”, it shows that the remote controller signal 90a is not received.

After the process in the step S301, the CPU 24 advances to the step S5 so as to determine a content of the key operation carried out in the step S3 or the key operation recognized by the decoding process in the step S57 in FIG. 14 (FIG. 8). Then, in a case that it is determined that the channel selecting operation is carried out in the step S5, and after the channel is set according to the channel selecting operation in the step S15, the CPU 24 processes a step S303.

That is, in the step S303, the CPU 24 determines whether or not the above-described flag S is “1”, and when “1”, the CPU 24 recognizes that the channel selecting operation is carried out by the HDR-use remote controller 90 before advancing to a step S305. Then, after rendering the flag Fs “1” in the step S305, the video-recording operation (simultaneous video-recording) is started in a step S307. Next, after starting the video-recording operation, the CPU 24 returns to the step S3. On the other hand, in a case that it is determined that the flag S is not “1” (that is, “0”) in the step S303, the CPU 24 directly returns to the step S3 from the step S303. Operations other than this in FIG. 13 are the same as that of the FIG. 6, and therefore, a duplicate description is omitted here.

Referring to FIG. 14, the CPU 24, if it is determined that the remote controller signal received in the step S59 is a signal transmitted from the HDR-use remote controller 90, advances to a step S309. Then, after rendering the flag S “1” in the step S309, the process returns to the step S5 in FIG. 13. On the other hand, if it is determined that the remote controller signal received in the step S59 is not a signal transmitted from the HDR-use remote controller 90, the CPU 24 directly returns to the step S5 from the step S59. Operations other than this in FIG. 14 are the same as that of the FIG. 8, and therefore, a duplicate description is are omitted here.

As understood from the above descriptions, according to the second embodiment, if the channel selecting operation is carried out by the HDR-use remote controller 90, a TV program of the channel corresponding to the channel selecting operation is video-recorded into the hard disk video recorder 100 (hard disk 22). At the same time, the same TV program as the TV program that the video-recording is being performed is displayed on the display screen of the television receiver 60. Therefore, similar to the above-described first embodiment, it is possible to watch/listen to the TV program going backward to the past.

It is noted that in the second embodiment, the remote controller signal 90a irradiated from the HDR-use remote controller 90 when the channel selecting operation is carried out by the HDR-use remote controller 90 corresponds to a selection instruction.

In the above-described embodiment, the present invention is described by referring to a case that the hard disk video recorder 10 or 100 is applied, however, it is not always the case. The present invention is also applicable to an apparatus that uses voices or sounds as an object to be recorded, such as an audio recorder with radio.

Furthermore, although the hard disk 22 is used as a recording medium, other recording media may be used. However, it is noted that a randomly accessible and high-speed accessible disk recording medium such as a DVD (Digital Versatile Disk), and etc, or a semiconductor memory may be more appropriate in use for implementing the present invention.

Moreover, although the MPEG 2 format is adopted as a video data compression method by the recording reproducing apparatus 20, other compression methods such as a motion JPEG (Motion Joint Photographic Expert Group), and etc, may be adopted.

Furthermore, by providing a plurality of tuner circuits 16, TV programs of different channels may be simultaneously recorded.

In addition, in the first embodiment, a turning-ON/OFF of a power source of the hard disk video recorder 10 may be operated by the TV-use remote controller 70. Then, in the second embodiment, the turning-ON/OFF of the power source of the television receiver 60 may be operated by the HDR-use remote controller 90.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content recording apparatus applied to a content outputting apparatus which outputs a content signal selected in response to a selection instruction out of a plurality of content signals, comprising:
an inputter for inputting said plurality of content signals;
a first receiver for receiving said selection instruction;
a selector for selecting any one of said plurality of content signals input by said inputter in response to said selection instruction received by said first receiver;
a first recorder for recording into a recording medium the content signal selected by said selector, said recording medium including a first zone and a second zone, said first recorder recording into said first zone the selected content signal;
a second receiver that receives a recording instruction; and
a second recorder that records into said second zone of said recording medium a desired content signal when receiving said recording instruction by said second receiver.

2. A content recording apparatus according to claim 1, wherein said first recorder cyclically records into said first zone said content signal.

3. A content recording apparatus according to claim 2, further comprising a disabler that disables said first recorder when a recording is carried out by said second recorder.

4. A content recording apparatus according to claim 1, wherein said recording medium is a disk recording medium.

5. A TV program video-recording apparatus applied to a television receiver that outputs a TV program signal selected in response to a selection instruction out of a plurality of TV program signals, comprising:
an inputter for inputting said plurality of TV program signals;
a first receiver for receiving said selection instruction;
a selector for selecting any one of said plurality of program signals input by said first inputter in response to said selection instruction received by said receiver;
a first recorder for recording into a recording medium the TV program signal selected by said selector, said recording medium including a first zone and a second zone, and said first recorder recording into said first zone the selected TV program signal;
a second receiver that receives a recording instruction; and
a second recorder that records into said second zone of said recording medium a desired TV program signal when receiving said recording instruction by said second receiver.

6. A TV program recording apparatus having a recoding medium and applicable to a television receiver which has a first receiving circuit that receives a channel selecting remote controller signal from a TV-use remote controller and sets a certain channel in response to the channel selecting remote controller signal, comprising:
a tuner circuit capable of receiving a TV program of an arbitrary channel;
a second receiving circuit that receives said channel selecting remote controller signal;
a CPU that sets said certain channel in said tuner circuit when receiving said channel selecting remote controller signal by said receiving circuit; and
a recording circuit that records into said recording medium a TV program of said certain channel output from said tuner circuit in response to an instruction from said CPU.
